(19) United States
(12) Patent Application Publication
(10) Pub. No.: US 2008/0049328 A1
(43) Pub. Date: Feb. 28, 2008

(54) Tunable diffraction grating having electro-optic material and method for operating same

(76) Inventor: Haixin Zhou, Beijing (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/510,034

(22) Filed: Aug. 25, 2006

(51) Int. Cl. G02B 5/18; G02B 27/44

(52) U.S. Cl. 359/566

(57) ABSTRACT

A tunable diffraction grating includes electro-optic material between a first electrode and a second electrode and an electric bias element coupled to the first electrode and the second electrode, whereby an optical characteristic of the electro-optic material is alterable by the electric bias element so as to dynamically alter a diffractive performance of the tunable diffraction grating.

### BACKGROUND

A diffraction grating is a reflective, or transparent element, the optical properties of which are periodically modulated. A diffraction grating is typically used to separate light of different wavelengths. When light is incident on a diffraction grating, diffractive and mutual interference effects occur and the incident light is reflected or transmitted in different directions, called diffraction orders. A diffraction grating is useful for separating spectral lines associated with atomic transitions. A diffraction grating acts as a “super prism,” accurately separating the different wavelengths of light. Because of their dispersive properties, diffraction gratings are commonly used in monochromators and spectrometers.

A diffraction grating is ruled with closely-spaced, parallel grooves that produce interference patterns in a way that separates the components of the incident light. A diffraction grating is typically designated by a “groove density,” which is expressed in grooves per millimeter (g/mm). The dimension and period of the grooves are on the order of the wavelengths sought to be separated.

One of the main characteristics of a diffraction grating is its diffraction efficiency. Diffraction efficiency is determined by the ratio of the power of the diffracted light beam (P_{diff}) to the incident power of the light beam (P_{inc}) and is given by the equation η=P_{diff}/P_{inc}. A high diffraction efficiency is particularly desirable when wavefront quality or when high signal to noise ratio is important.

Unfortunately, the diffraction efficiency is rarely constant and instead varies considerably as a function of wavelength. This behavior is a natural result of the interaction of light with a modulated surface and because light will always be diffracted into at least two orders when there is useful dispersion. Maintaining a high diffraction efficiency over a wide spectral range is particularly desirable.

In addition, the diffraction efficiency differs in the two different planes of polarization. The two planes of polarization are defined as having the electrical vector parallel to the grooves (the TE plane) or perpendicular to the grooves (the TM plane). Non-polarized (NP) incident light will be partially polarized after diffraction. In some applications, such as in an optical spectrum analyzer, high diffraction efficiency for both planes of polarization is desirable.

One prior art methodology for maximizing diffraction efficiency for both polarization planes is to precisely control the parameters of the grooves during grating fabrication. This includes the ratio of the wavelength to groove spacing (λ/d), the grove depth modulation (h/d), and the geometry of the groove.

Another prior art methodology involves coating the diffraction grating with a material that is chosen to improve the performance of the grating. Unfortunately, these prior solutions result in a narrow spectral interval, close groove tolerances and have a high polarization dependent loss.

Yet another prior art methodology for improving grating efficiency involves the use of a combination of a multilayer dielectric stack with alternating low and high optical indices on a highly efficient metal or dielectric grating. However, such a methodology improves the performance of the grating only in a narrow spectral interval and is costly to implement.

Further, all of these prior solutions require implementation during the grating design and fabrication process.

Therefore, it would be desirable to have a diffraction grating in which the diffraction efficiency can be maximized over a wide performance range.

### SUMMARY

A tunable diffraction grating comprises electro-optic material between a first electrode and a second electrode and an electric bias element coupled to the first electrode and the second electrode, whereby an optical characteristic of the electro-optic material is alterable by the electric bias element so as to dynamically alter a diffractive performance of the tunable diffraction grating.

A method for operating a diffraction grating comprises calibrating the tunable diffraction grating to determine electric field, frequency and polarization parameters, storing the electric field, frequency and polarization parameters in memory, providing incident light to the tunable diffraction grating, obtaining feedback on the performance of the tunable diffraction grating and adjusting an electrical bias signal applied to the tunable diffraction grating to alter a performance characteristic of the tunable diffraction grating.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an embodiment of a tunable diffraction grating.

FIG. 2 is a schematic diagram illustrating an alternative embodiment of a tunable diffraction grating.

FIG. 3 is a schematic diagram illustrating a tunable diffraction grating in an optical system.

FIG. 4 is a flowchart describing an exemplary method of operating a tunable diffraction grating.

FIGS. 5A through 5G are schematic diagrams showing example grating profiles for a tunable diffraction grating.

### DETAILED DESCRIPTION

Embodiments of the tunable diffraction grating and method for operating same are dynamically tunable during use. The tunable diffraction grating can be fabricated using semiconductor-based technologies known to those skilled in the art.

The tunable diffraction grating is based on the realization that a tunable diffraction grating can be fabricated using a material that exhibits electro-optic properties. A material that exhibits electro-optic properties is one in which the optical properties of the material are modified by an electric field. The electro-optic effect generally relates to a change in the optical properties of a material as a result of the application of an electric field in the vicinity of the electro-optic material. The change in the optical properties of the material can be a change in the birefringence of the material or a change in the refractive index of the material.

Birefringence, also referred to as double refraction, is the decomposition of a ray of light into two rays (the ordinary ray and the extraordinary ray) when it passes through certain types of material, such as a calcite crystals, depending on the polarization of the light. This effect occurs when the structure of the material is anisotropic. If the material has a single axis of anisotropy, (i.e. it is uniaxial,) birefringence can be formalized by assigning two different refractive indices to the material for different polarizations. The birefringence magnitude is then defined by:

Δn=nₑ−n₀ (1),

where nₒ and nₑ are the refractive indices for polarizations perpendicular and parallel to the axis of anisotropy respectively. These rays are labeled “ordinary” and “extraordinary” respectively.

Birefringence can also arise in magnetic, not dielectric, materials, but substantial variations in magnetic permeability of materials are rare at optical frequencies.

The refractive index, also referred to as index of refraction, of a material is the factor by which the phase velocity of electromagnetic radiation is slowed in that material, relative to its velocity in a vacuum. It is usually given the symbol n, and defined for a material by:

η=\sqrt{εrμr} (2),

where εᵣ is the material's relative permittivity, and μᵣ is its relative permeability. For a non-magnetic material, μᵣ is very close to 1, therefore n is approximately

\sqrt{εr} (3).

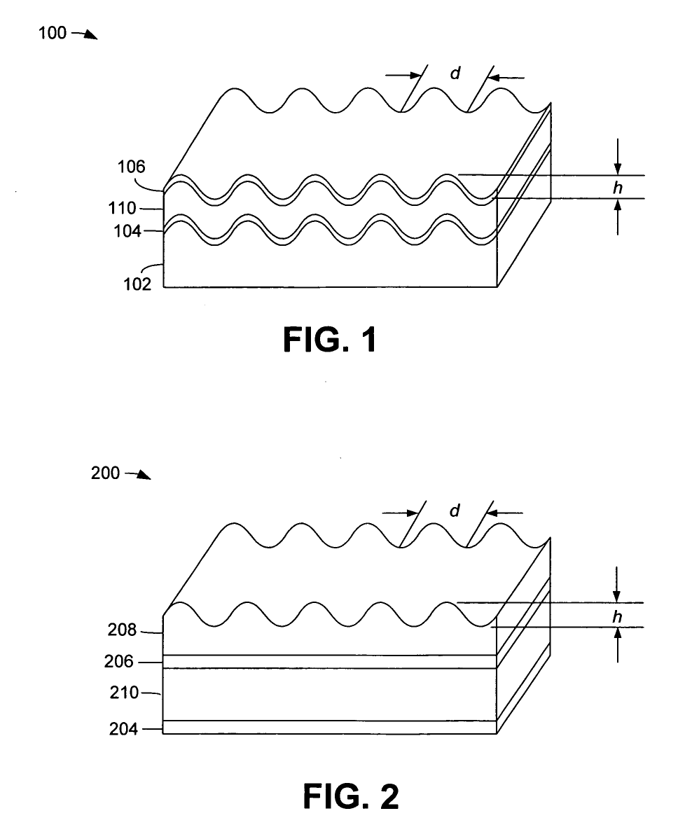

FIG. 1 is a schematic diagram illustrating an embodiment of a tunable diffraction grating. The tunable diffraction grating described in FIG. 1 is referred to as a reflective device in that incident light is reflected from a surface of the diffraction grating. Alternatively, the principles to be described below are also applicable to a transmissive diffraction grating if the materials of the diffraction grating are chosen to be transparent at the range of wavelengths of the incident light. A transmissive diffraction grating is one in which the incident light is transmitted through the grating.

The tunable diffraction rating 100 comprises a substrate 102 over which a first, also referred to as a “bottom,” electrode 104 is formed. The terms “bottom” and “top” are arbitrary and are not intended to define a particular orientation of the tunable diffraction grating 100. In an embodiment, the substrate can be c-plane sapphire, lanthanum aluminum oxide (LaAlO₃), glass, such as Corning 7079, or any suitable substrate material over which the first electrode 104 can be formed. A layer 110 of electro-optic material is formed over the first electrode 104. The electro-optic material can be a transparent ferroelectric material having a strong opto-electric characteristic and that possesses a high refractive index in the wavelength range from infrared to visible light. In an embodiment, the electro-optic material has a refractive index of approximately 2.0 through approximately 2.6; however, other refractive indices are possible. In an embodiment, the electro-optic material can be, for example, lead lanthanum zirconate titanate, abbreviated as PLZT, or barium strontium titanate, abbreviated BST. A second, also referred to as a “top,” electrode 106 is formed over the electro-optic material layer 110.

In an embodiment, the first electrode 104 is germanium (Ge) formed to a thickness of approximately 100 nanometers (nm). The electro-optic material layer 110 can be PLZT, BST, or another electro-optic material formed to a thickness of, in this example, approximately 300 nm. In this embodiment, the second electrode 106 can be gold (Au), platinum (Pt) or another suitable electrode material formed to a thickness of approximately 100 nm. The formation of materials on a substrate can be performed using semiconductor manufacturing techniques, such as metal-organic chemical vapor deposition (MOCVD), molecular beam epitaxy (MBE), organo-metallic vapor phase epitaxy (OMVPE), etc., which are known in the art. Alternatively, the materials can be formed by sputtering using, for example, radio frequency (RF) or magnetic sputtering or using pulsed laser deposition (PLD). The thicknesses of the first electrode 104, the electro-optic material layer 110 and the second electrode 106 can be varied based on the desired diffraction performance of the tunable diffraction grating 100. For example, the thickness of the first electrode 104 can range between approximately 50 nm to approximately 150 nm, the thickness of the electro-optic material layer 110 can range between approximately 250 nm to approximately 350 nm and the thickness of the second electrode 106 can range between approximately 50 nm to approximately 150 nm.

In the embodiment of FIG. 1, the first electrode 104, electro-optic material layer 110 and the second electrode 106 form a sinusoidal reflective diffraction grating that is tunable over a range of wavelengths. In an embodiment, the diffraction grating 100 includes a grating period (d) having approximately 600 grooves per millimeter (gr/mm) and has a groove depth (h) of approximately 620 nanometers (nm) for application in the optical communications band. However, diffraction gratings having other groove characteristics can be used in accordance with the embodiments of the invention. Alternatively, other profiles such as triangular, trapezoidal, rectangular, and modulated sine/cosine are all possible using the techniques described herein. The grating period (d) is typically in the vicinity of the operating wavelength (lambda (λ)), and may be a little larger than the operating wavelength. The groove depth (h) is normally chosen to be 10% to 60% of the grating period (d). However, for specific applications the value of h/d may range between approximately 5%, and approximately 80-90% or even higher.

As will be described more fully below, applying an electric field to the diffraction grating 100 dynamically modifies the optical properties of the electro-optic material layer 110. The application of an electric field to the electro-optic material layer 110 by the first electrode 104 and the second electrode 106 changes the dielectric constant of the material that comprises the electro-optic material layer 110. Changing the dielectric constant of the material that comprises the electro-optic material layer 110 changes the diffraction efficiency of the tunable diffraction grating 100. For example, in an embodiment, applying an electric field of approximately 10 volts per micrometer (V/μm) to the electro-optic material layer 110 can change the refractive index of electro-optic material layer 110 by approximately 2%. The physical quantity that characterizes how the incident field power is distributed between the different orders is called diffraction efficiency. Diffraction efficiency is the ratio between the energy flow of a particular order in a direction perpendicular to the grating surface and the corresponding flow of the incident wave through the same surface.

The diffractive performance of the diffraction grating is generally a result of the diffraction efficiency of a certain diffractive order. Maintaining high diffraction efficiency in a wide spectrum range is highly desirable. It is desirable that the diffraction efficiency be as high as possible, and preferably 90-95%, for many applications. For less critical applications the diffraction efficiency can be on the order of 70%. Using current grating fabrication techniques, it is possible to reach 90% diffraction efficiency over a range of approximately 100 nm for a single polarization. By implementing the principles described herein, it is possible to achieve approximately 90% or higher diffraction efficiency over a range of approximately 300 nm for one polarization or both polarizations.

In addition to the groove parameters, which include the ratio of wavelength to groove spacing (λ/d), the groove depth modulation (h/d), and the groove geometry, the optical properties of the coating material influence the diffractive performance of the tunable diffraction grating. In the example of FIG. 1, the coating comprises the first electrode 104, the electro-optic material layer 110 and the second electrode 106. The choice of material and thickness of the layers that form the first electrode 104, the electro-optic material layer 110 and the second electrode 106 influence the diffraction efficiency and diffraction performance of the tunable diffraction grating 100. For example, the thickness of the material that forms the first electrode 104, the electro-optic material layer 110 and the second electrode 106 can be adjusted as described above to obtain a desired diffraction performance.

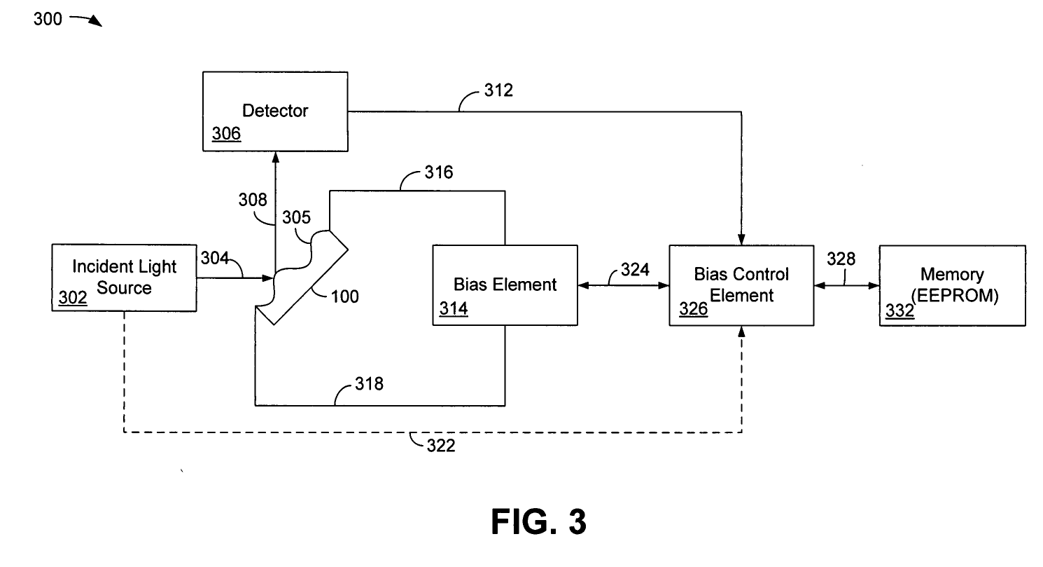

A challenge with the fabrication of a tunable diffraction grating as shown in FIG. 1 arises from profile degradation during the growth of the layers of the device. An alternative embodiment of a tunable diffraction grating that minimizes profile degradation is shown in FIG. 2.

Alternatively, a magnetically biased ferrite is can be used to alter the diffraction efficiency of the tunable diffraction grating 100. However, a magnetically biased ferrite requires a cumbersome magnetic biasing system and results in relatively slower tuning speed.

FIG. 2 is a schematic diagram illustrating an alternative embodiment of a tunable diffraction grating. The tunable diffraction grating described in FIG. 2 is a transmissive device in that the materials of the device 200 are chosen to be transparent at the range of wavelengths of the incident light so that incident light passes through the diffraction grating. Alternatively, the principles to be described below are also applicable to a reflective diffraction grating if the materials of the diffraction grating are chosen to be reflective at the range of wavelengths of the incident light.

The tunable diffraction rating 200 comprises a first electrode, also referred to as a “bottom” electrode, 204 over which a layer 210 of electro-optic material is formed. The electro-optic material layer 210 is similar to the electro-optic material layer 110 described above. The tunable diffraction grating 200 is transmissive and therefore, does not include a substrate.

A second, also referred to as a “top,” electrode 206 is formed over the electro-optic material layer 210. A dielectric grating layer 208 is formed over the second electrode 206 using, for example, lanthanum aluminum oxide (LaAlO₃).

In an embodiment, the first electrode 204 is germanium (Ge) formed to a thickness of approximately 100 nanometers (nm). The electro-optic material layer 210 can be PLZT, BST, or another electro-optic material formed to a thickness of, in this example, approximately 300 nm. In this embodiment, the second electrode 206 can be gold (Au), platinum (Pt) or another suitable electrode material formed to a thickness of approximately 100 μm. The dielectric grating layer 208 is lanthanum aluminum oxide and is formed to a thickness of approximately 300 nm in this example. Alternatively, any dielectric material normally used for dielectric gratings with good optic performance within the desired spectrum range can be used to form the dielectric grating layer 208.

The formation of materials can be performed using semiconductor manufacturing techniques, such as metal-organic chemical vapor deposition (MOCVD), molecular beam epitaxy (MBE), organo-metallic vapor phase epitaxy (OMVPE), etc., which are known in the art. Alternatively, the materials can be formed by sputtering using, for example, radio frequency (RF) or magnetic sputtering or using pulsed laser deposition (PLD). The thicknesses of the first electrode 204, the electro-optic material layer 210, the second electrode 206 and the dielectric grating layer 208 can be varied based on the desired diffraction performance of the tunable diffraction grating 200. For example, the thickness of the first electrode 204 can range between approximately 50 nm to approximately 150 nm, the thickness of the electro-optic material layer 210 can range between approximately 250 nm to approximately 350 nm, the thickness of the second electrode 206 can range between approximately 50 nm to approximately 150 nm and the thickness of the dielectric grating layer 208 can range between approximately 250 nm to 350 nm.

The first electrode 204, electro-optic material layer 210 the second electrode 206 and the dielectric grating layer 208 form a sinusoidal transmissive diffraction grating that is tunable over a range of wavelengths. In an embodiment, the diffraction grating 200 includes a grating period (d) having approximately 600 grooves per millimeter (gr/mm) and has a groove depth (h) of approximately 620 nm, for application in the optical communications band. However, diffraction gratings having other groove characteristics can be used in accordance with the embodiments described above. Alternatively, other profiles such as triangular, trapezoidal, rectangular, and modulated sine/cosine are all possible using the techniques described herein.

As will be described more fully below, applying an electric field to the diffraction grating 200 dynamically modifies the optical properties of the electro-optic material layer 210. The application of an electric field to the electro-optic material layer 210 changes the dielectric constant of the material that comprises the electro-optic material layer 210. Changing the dielectric constant of the material that comprises the electro-optic material layer 210 changes the diffractive performance of the tunable diffraction grating 200. For example, in an embodiment, applying an electric field of approximately 10 volts per micrometer (V/μm) can change the refractive index of the electro-optic material 210 by approximately 2% and therefore dynamically modify the diffractive performance of the tunable diffraction grating 200.

In addition to the groove parameters, which include the ratio of wavelength to groove spacing (λ/d), the groove depth modulation (h/d), and the groove geometry, the optical properties of the coating material influence the diffractive performance of the tunable diffraction grating. In the example of FIG. 2, the coating comprises the first electrode 204, the electro-optic material layer 210, the second electrode 206 and the dielectric grating layer 208. The choice of material and thickness of the layers that form the first electrode 204, the electro-optic material layer 210, the second electrode 206 and the dielectric grating layer 208 influence the diffraction efficiency and diffraction performance of the tunable diffraction grating 200. For example, the thickness of the material that forms the first electrode 204, the electro-optic material layer 210, the second electrode 206 and the dielectric grating layer 208 can be adjusted as described above to obtain a desired diffraction performance.

The tunable diffraction grating 200 substantially eliminates the problem of profile degradation during layer growth by reducing the number of layers that are used to form the grating profile. In this manner, it is possible to grow the tunable diffraction grating 200 to a thickness greater than the thickness of the tunable diffraction grating 100.

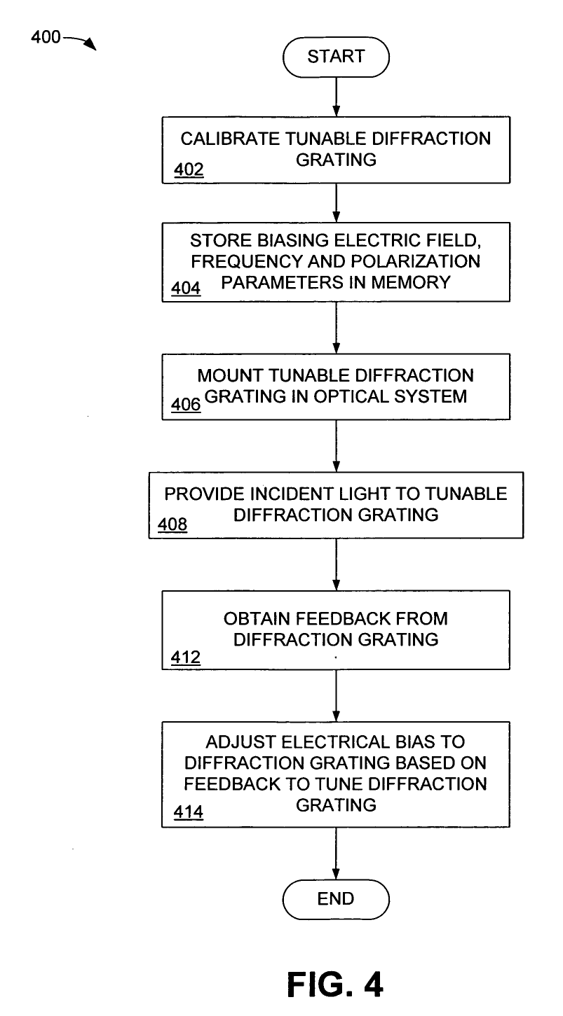

FIG. 3 is a schematic diagram illustrating a tunable diffraction grating in an optical system. The optical system 300 includes a tunable diffraction grating 100 electrically coupled to an electric bias element 314. In an embodiment, the electric bias element 314 includes electrical conductors 316 and 318 that are electrically connected to the first and second electrodes (not shown in FIG. 3) of the tunable diffraction grating 100. In an embodiment, the electric bias element 314 is a direct current (DC) bias element that is configured to apply a DC electrical voltage signal to the electrodes 104 and 106 (FIG. 2) of the tunable diffraction grating 100. In an alternative implementation, the tunable diffraction grating 200 may be implemented in the optical system 300 instead of the tunable diffraction grating 100.

An incident light source 302 directs light onto a surface 305 of the tunable diffraction grating 100 along the path indicated as 304. The path 304 is indicated as a single line; however, the incident light may comprise a number of wavelengths and may illuminate the entire surface 305 of the tunable diffraction grating 100. Because in this example the tunable diffraction grating 100 is a reflective device, the incident light 304 is reflected from the surface 305 of the tunable diffraction grating 100 in the direction indicated using arrow 308 toward a detector 306. The light 308 is separated into different orders and different wavelengths depending on the optical characteristics of the tunable diffraction grating 100. The detector 306 is configured to detect the wavelengths of light that are diffracted by the tunable diffraction grating 100.

The detector 306 and the electric bias element 314 are also electrically coupled, via respective connections 312 and 324, to a bias control element 326. The connection 324 between the electric bias element 314 and the bias control element 326 is a bi-directional connection. In an embodiment, the incident light source 302 is also electrically coupled via connection 322 to the bias control element 326. The bias control element 326 is electrically coupled via bi-directional connection 328 to a memory element 332. In an embodiment, the memory element 332 can be, for example, an electrically erasable programmable read only memory (EEPROM). However, other types of non-volatile memory may be used. The memory element 332 is used to store the operational parameters of the tunable diffraction grating 100.

An electric bias signal is supplied by the electric bias element 314 to the tunable diffraction grating 100 to dynamically alter the refractive index of the electro-optic material (not shown in FIG. 3) and thus alter the diffractive performance of the tunable diffraction grating 100. The electric bias signal establishes an electric field in the vicinity of the electro-optic material layer 110 (FIG. 1), thus altering the refractive index of the electro-optic material layer 110. In an embodiment, the tuning range of the tunable diffraction grating can be on the order of a few volts for a tunable diffraction grating having an electro-optic material layer 110 (FIG. 1) of several hundred nm in thickness, as described above.

Data relating the level of the electric bias signal, the effective operating range in frequency of the tunable diffraction grating, and the polarization are stored in the memory element 332. The tunable diffraction grating 100 can be calibrated before it is mounted into the system 300, and the optimum strength of the biasing electric field vs. frequency vs. polarization according to the current mounting is stored in the nonvolatile memory 332. The bias voltage alters the refractive index of the electro-optic material 110 and therefore alters the diffractive performance of the tunable diffraction grating 100. In this example, the frequency and the polarization refer to the incident light. Each diffraction grating has different diffraction efficiency at a certain diffractive order with different incident frequencies and polarizations. The tunability of the electro-optic material (and therefore the diffraction grating) allows the diffraction efficiency to be optimization of over a wider spectrum and for both incident polarizations.

The bias control element 326 receives feedback from the detector 306 and optionally from the incident light source 302 to provide optimal control of the electrical bias signal applied to the tunable diffraction grating.

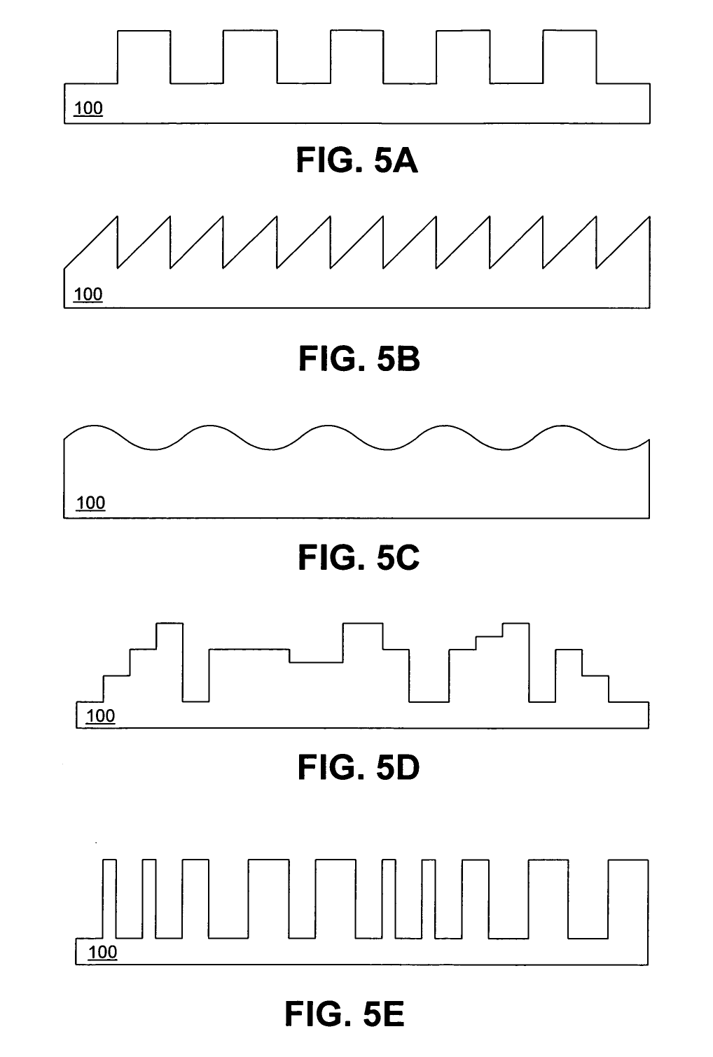

FIG. 4 is a flowchart 400 describing an exemplary method of operating a tunable diffraction grating. In block 402, the tunable diffraction grating is calibrated. For example, a factory calibration is performed to determine the static parameters of the tunable diffraction grating 100. After this calibration, the optimized biasing strength vs. incident frequency vs. incident polarization can be stored in the memory 332 (FIG. 3).

In block 404, the biasing electric field parameters, the frequency parameters and the polarization parameters are stored in the memory 332. In block 406, the tunable diffraction grating 100 is mounted in an optical system. However, the tunable diffraction grating 100 may be mounted in the optical system 300 prior to calibration. In block 408, incident light having a range of different wavelengths is directed to the tunable diffraction grating 100.

In block 412, feedback is provided from the detector 306, and optionally, from the incident light source 302, on the performance of the tunable diffraction grating 100 based on the light reflected from the surface of the tunable diffraction grating 100. In block 414, the bias control element 326 analyzes the feedback signal, which is indicative of the performance of the tunable diffraction grating 100. The bias control element 326 provides a control signal to the electric bias element 314 so that the electric bias element 314 can alter the bias signal applied to the tunable diffraction grating 100. In this manner, the diffraction performance of the tunable diffraction grating 100 is dynamically adjustable over a range of wavelengths and for different incident polarizations, thus extending the performance capabilities of such a tunable diffraction grating.

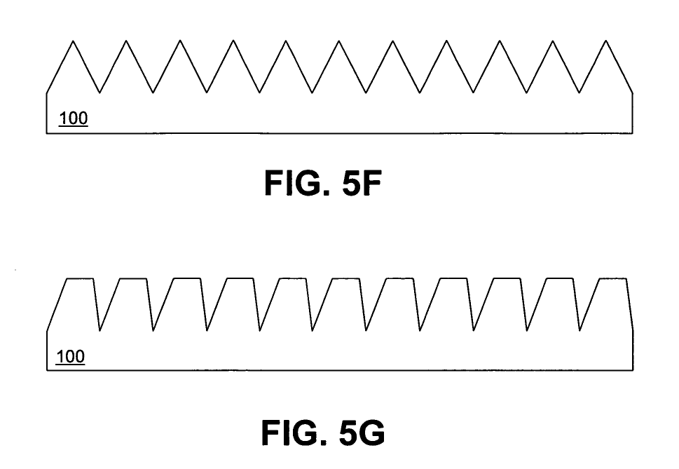

FIGS. 5A through 5G are schematic diagrams showing example grating profiles for the tunable diffraction grating 100 of FIG. 1. However, the grating profiles of FIGS. 5A through 5E are also applicable to the tunable diffraction grating 200 of FIG. 2. FIG. 5A shows a binary grating profile, wherein an optical signal from the incident light source 302 (FIG. 3) is diffracted according to alternating steps in the grating profile. FIG. 5B shows a sawtooth grating profile, wherein an optical signal from the incident light source 302 (FIG. 3) is diffracted according to a series of ramps in the grating profile.

FIG. 5C shows a sinusoidal grating profile, as described above, wherein an optical signal from the incident light source 302 (FIG. 3) is diffracted according to sinusoidal thickness variations in the grating profile. FIG. 5D shows a multiple phase level grating profile wherein an optical signal from the incident light source 302 (FIG. 3) is diffracted according to stepped thickness variations in the grating profile. FIG. 5E shows a grating profile having a binary sub-wavelength profile wherein an optical signal from the incident light source 302 (FIG. 3) is diffracted as described in Vector-based Synthesis Of Finite Aperiodic Subwavelength Diffractive Optical Elements, by Prather et al., Journal of the Optical Society of America, Vol. 15, No. 6, June 1998, hereby incorporated by reference. FIG. 5F shows a triangular grating profile, wherein an optical signal from the incident light source 302 (FIG. 3) is diffracted according to a series of triangular shaped features in the grating profile. FIG. 5G shows a trapezoidal grating profile, wherein an optical signal from the incident light source 302 (FIG. 3) is diffracted according to a series of trapezoidal shaped features in the grating profile. A modulated sine or cosine grating profile can be described according to the following equations. A power-sine grating profile can be described by the equation:

$$y = h [ {{sin}^{2} ( \frac{2 π}{d} x ]}^{σ} \qquad ( 4 )$$

where d is the grating period, h is the groove depth and σ is an exponent greater than 0.

An inverted power-sine grating profile can be described by the equation:

$$y = h \{ 1 - {[ {cos}^{2} ( \frac{2 π}{d} x ) ]}^{σ} \} \qquad ( 5 )$$

where d is the grating period, h is the groove depth and σ is an exponent greater than 0.

The tunable diffraction grating provides one more means to adjust the diffraction performance of a diffraction grating and substantially reduces or in some applications eliminates the tight tolerance on grating design and fabrication, and also makes it possible that a single design can be adopted in multiple applications, which drastically reduces the manufacturing cost.

This disclosure describes the invention in detail using illustrative embodiments. However, it is to be understood that the invention defined by the appended claims is not limited to the precise embodiments described.

What is claimed is:

1. A tunable diffraction grating, comprising:
an electro-optic material between a first electrode and a second electrode; and
an electric bias element coupled to the first electrode and the second electrode, whereby an optical characteristic of the electro-optic material is alterable by the electric bias element so as to dynamically alter a diffractive performance of the tunable diffraction grating.

2. The tunable diffraction grating of claim 1, in which the first electrode, the second electrode and the electro-optic material form a diffraction grating having a profile chosen from sinusoidal, triangular, trapezoidal, rectangular, binary subwavelength and modulated sine/cosine.

3. The tunable diffraction grating of claim 1, in which the electro-optic material is chosen from lead lanthanum zirconate titanate (PLZT) and barium strontium titanate (BST).

4. The tunable diffraction grating of claim 1, in which the electro-optic material has a refractive index between approximately 2.0 and 2.6 in the wavelength range between infrared and visible light.

5. The tunable diffraction grating of claim 4, in which the electric bias element applies an electric field of approximately 10 V/μm between the first electrode and the second electrode, and the electric field changes a refractive index of the electro-optic material by approximately 2%.

6. The tunable diffraction grating of claim 1, in which the first electrode, electro-optic material and the second electrode are located over a substrate.

7. The tunable diffraction grating of claim 1, further comprising a dielectric grating material located over the first electrode, electro-optic material and the second electrode.

8. A method for operating a tunable diffraction grating, comprising:
calibrating the tunable diffraction grating to determine electric field, frequency and polarization parameters;
storing the electric field, frequency and polarization parameters in memory;
providing incident light to the tunable diffraction grating;
obtaining feedback on the performance of the tunable diffraction grating; and
adjusting an electrical bias signal applied to the tunable diffraction grating to alter a performance characteristic of the tunable diffraction grating.

9. The method of claim 8, in which adjusting the electrical bias signal applied to the tunable diffraction grating changes a refractive index of the electro-optic material.

10. The method of claim 9, in which adjusting the electrical bias signal applied to the tunable diffraction grating further comprises applying an electric field of approximately 10 V/μm.

11. The method of claim 10, further comprising changing a refractive index of the electro-optic material approximately 2% as a result of the application of the approximate 10 V/μm electric field.

12. The method of claim 11, in which the feedback is provided by an element chosen from an incident light source and a detector.

13. The method of claim 8, in which the electrical bias signal is applied to a layer of electro-optic material.

14. A tunable diffraction grating, comprising:
an electro-optic material between a first electrode and a second electrode;
a dielectric grating located over the second electrode, the dielectric grating forming a sinusoidal dielectric grating; and
an electric bias element coupled to the first electrode and the second electrode, whereby a refractive index of the electro-optic material is alterable by the electric bias element so as to dynamically alter a diffractive performance of the tunable diffraction grating.

15. The tunable diffraction grating of claim 14, in which the electro-optic material is chosen from lead lanthanum zirconate titanate (PLZT) and barium strontium titanate (BST).

16. The tunable diffraction grating of claim 14, in which the electro-optic material has a refractive index between approximately 2.0 and 2.6 in the wavelength range between infrared and visible light.

17. The tunable diffraction grating of claim 15, in which the electric bias element applies an electric field of approximately 10 V/μm between the first electrode and the second electrode, and the electric field changes a refractive index of the electro-optic material by approximately 2%.

18. The tunable diffraction grating of claim 17, further comprising a bias control element coupled to the electric bias element and a memory coupled to the bias control element.

19. The tunable diffraction grating of claim 18, in which the memory stores operational parameters of the tunable diffraction grating chosen from bias voltage level, operating frequency and polarization.

20. The tunable diffraction grating of claim 19, further comprising a detector configured to receive light diffracted by the tunable diffraction grating, the detector also coupled to the bias control element and configured to provide performance feedback to the bias control element.
